(19) United States
(12) Patent Application Publication
(10) Pub. No.: US 2012/0263056 A1
(43) Pub. Date: Oct. 18, 2012

(54) APPARATUS, METHODS, AND ARTICLES OF MANUFACTURE FOR WIRELESS COMMUNICATIONS

(76) Inventors: David Smith, (US); Jeremy Rode, San Diego, CA (US); Anis Husain, San Diego, CA (US); Maha Achour, Encinitas, CA (US)

(21) Appl. No.: 13/440,796

(22) Filed: Apr. 5, 2012

Related U.S. Application Data
(60) Provisional application No. 61/476,205, filed on Apr. 15, 2011.

(51) Int. Cl. H04W 24/00; H01Q 21/28; H04B 7/08; H04B 5/00; H04L 5/00

(52) U.S. Cl. 370/252; 455/41.1; 370/297; 455/272; 343/836

(57) ABSTRACT

Selected embodiments are directed to methods, apparatus, and articles of manufacture for wireless radio frequency communications. Adjacent antenna array elements of a receiver antenna array are separated by less than the diffraction limit of the radio frequency communication band in which the apparatus and methods operate. A plurality or multiplicity of near-field scatterers are asymmetrically placed in the immediate vicinity of each of the antenna array elements, to perturb the pattern of each of the antenna elements, making the patterns different even below diffraction limit spacing. A transmitter spatially and temporally focuses simultaneous transmissions on each of the antenna array elements, using time reversal communication techniques. The transmitter may transmit through multiple antenna elements, and the channel from the transmitter to the receiver may be subject to multipath phenomena.

### CROSS-REFERENCE TO RELATED APPLICATIONS

The present application claims priority from U.S. Provisional Patent Application Ser. No. 61/476,205, entitled TIME REVERSAL COMMUNICATION SYSTEMS WITH NEAR-FIELD SCATTERERS, filed on 15 Apr. 2011, which is hereby incorporated by reference in its entirety as if fully set forth herein, including text, figures, claims, tables, and computer program listing appendices (if present).

### FIELD OF THE INVENTION

This document relates generally to apparatus, methods, and articles of manufacture for wireless communication systems.

### BACKGROUND

There is a substantial and rapidly growing interest in high data rate wireless communications, including communications in urban and other environments that may lack strong Line-of-Sight (LOS) signals. Such environments include Non-Line-of-Sight (NLOS) signal environments, and weak LOS signal with severe multipath (MP) environments. Numerous radio frequency (RF) communication approaches have been proposed to address such environments. These approaches often focus primarily on diversity techniques like multiple-in-multiple-out (MIMO) techniques; smart adaptive antenna technologies; and/or the use of sophisticated signal processing, for example, Rake receivers and/or pilot assisted receivers. Many of these techniques attempt to provide the receiver (Rx) with an accurate estimate of the Channel Impulse Response (CIR) of the channel between the Rx and the transmitter (Tx), which may enable the receiver to separate (from a highly distorted incoming signal) data, multipath signals, and noise and other external interference. Some of these techniques have met with limited success, and some require sophisticated Digital Signal Processing (DSP) algorithms resulting in complex systems with high computational loads and corresponding power draw. Often, even these techniques have difficulty recovering the desired signal in severe multipath environments.

The use of MIMO can be quite advantageous, with increased diversity and energy capturing ability at the receiver. Multiple input antennas, however, typically have to be spaced a relatively large portion of the wavelength away from each other. For example, input antenna elements may have to be spaced at least one-half wavelength apart. This so-called diffraction limit imposes a lower limit on the physical dimensions of antenna arrays, limiting receiver miniaturization. At 300 MHz, for example, the free-space wavelength is approximately 1 meter, or 3.3 feet. Half-wavelength spacing of two antenna elements would thus result in a 1.65 foot width of the receiver antenna array, too large for a handheld radio.

Improved wireless communication methods are needed to increase communication rates, reliability, and robustness. Improved wireless communication methods are also needed to enable the use of multiple input antennas with small spacing of individual antenna elements.

### SUMMARY

Selected embodiments described in this document are directed to methods, apparatus, and articles of manufacture that may satisfy one or more of the above described and/or other needs. Some embodiments provide a receiver with an antenna array where adjacent antenna array elements are separated by less than the diffraction limit of the radio frequency communication band in which the apparatus and methods operate. A plurality or multiplicity of near-field scatterers are asymmetrically placed in the immediate vicinity of each of the antenna array elements, to perturb the pattern of each of the antenna elements, making the patterns different even below the diffraction limit. A transmitter spatially and temporally focuses simultaneous transmissions on each of the antenna array elements using time reversal communication techniques.

In an embodiment, a radio antenna array includes a plurality of antenna elements electrically insulated from each other, each antenna element of the plurality of antenna elements being configured to operate in a predetermined radio frequency (RF) band. The antenna array also includes a plurality of near-field (NF) scatterers. The plurality of antenna elements includes a first antenna element and a second antenna element, the first antenna element being separated from the second antenna element by a distance d, d being less than one-half wavelength at center frequency of the predetermined RF band. The NF scatterers of the plurality of NF scatterers are distributed asymmetrically relative to the first and second antenna elements, and each NF scatterer of a first subset of the NF scatterers of the plurality of NF scatterers is located nearer the first antenna element than d.

Each NF scatterer of a second subset of the NF scatterers of the plurality of NF scatterers may be located nearer the second antenna element than the distance d. Each antenna element of the array of antenna elements may be coupled to a different input of a receiver.

In an embodiment, an apparatus for receiving data transmissions includes the radio antenna array as described in the above paragraphs. The apparatus also includes an electronic receiver portion configured to operate in the predetermined frequency band using time reversal. The electronic receiver portion includes a plurality of antenna inputs, each antenna element of the array of antenna elements being coupled to a different input of the plurality of antenna inputs of the electronic receiver portion. The distance d may be less than one-half wavelength at all frequencies of the predetermined RF band.

In an embodiment, an apparatus for receiving radio frequency data transmissions includes an electronic receiver portion configured to operate in a predetermined frequency band using time reversal. The electronic receiver portion includes a plurality of antenna inputs. The apparatus also includes a multi-element antenna means for receiving electronic transmissions in the predetermined frequency band separately targeting each element of the multi-element antenna means. The elements of the multi-element antenna means may be spaced less than diffraction limit of the predetermined frequency band.

In an embodiment, a method of transmitting data wirelessly from a transmitter to a receiver uses time reversal communications in a predetermined radio frequency band. The method includes estimating a first channel response between the transmitter and a first antenna element of the receiver, and estimating a second channel response between the transmitter and a second antenna element of the receiver. The method also includes temporally and spatially focusing a first transmission of first data from the transmitter on the first antenna element. The method further includes temporally and spatially focusing a second transmission of second data from the transmitter on the second antenna element. The second antenna element is separated from the first antenna element by less than diffraction limit associated with the predetermined radio frequency band. The first and second transmissions may be sent concurrently.

In an embodiment, a method of receiving data is disclosed. The data is sent wirelessly from a transmitter to a receiver, using time reversal communications in a predetermined radio frequency band. The method includes sending a first sounding pulse from a first antenna element of the receiver to the transmitter, to help the transmitter to estimate the channel response between the transmitter and the first antenna element. The method also includes sending a second sounding pulse from a second antenna element of the receiver to the transmitter, to help the transmitter to estimate the channel response between the transmitter and the second antenna element. The method further includes receiving at the receiver through the first antenna element a first transmission temporally and spatially focused by the transmitter on the first antenna element. The method additionally includes receiving at the receiver through the first antenna element a first transmission temporally and spatially focused by the transmitter on the first antenna element. The second antenna element is separated from the first antenna element by less than diffraction limit associated with the predetermined radio frequency band. The first and second transmissions are received concurrently.

These and other features and aspects of selected embodiments not inconsistent with the present invention will be better understood with reference to the following description, drawings, and appended claims.

### BRIEF DESCRIPTION OF THE FIGURES

FIG. 1 is a block diagram showing selected elements of a transmitter embodiment configured in accordance with selected aspects described in this document;

FIG. 2 is a block diagram showing selected elements of a receiver embodiment configured in accordance with selected aspects described in this document;

FIG. 3 illustrates selected elements of an embodiment of a receiver antenna array of the receiver embodiment of FIG. 2;

FIG. 4 illustrates selected elements of another embodiment of a receiver antenna array of the receiver embodiment of FIG. 2; and

FIG. 5 illustrates selected steps and/or decision blocks of a method embodiment for time-reversal communication using near-field scatterers.

### DETAILED DESCRIPTION

In this document, the words “embodiment,” “variant,” “example,” and similar words and expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar words and expressions are used to indicate one of a number of different possible embodiments, variants, or examples. The number of possible embodiments, variants, or examples is not necessarily limited to two or any other quantity. Characterization of an item as “exemplary” means that the item is used as an example. Such characterization of an embodiment, variant, or example does not necessarily mean that the embodiment, variant, or example is preferred; the embodiment, variant, or example may but need not be a currently preferred embodiment, variant, or example. All embodiments, variants, and examples are described for illustration purposes and are not necessarily strictly limiting.

The words “couple,” “connect,” and similar expressions with their inflectional morphemes do not necessarily import an immediate or direct connection, but include within their meaning connections through mediate elements.

References to “receiver” (“Rx”) and “transmitter” (“Tx”) are made in the context of examples of data transmission from the transmitter to the receiver. For time reversal communication techniques, the receiver may need to transmit to the transmitter a sounding signal, e.g., a pulse or a pilot signal, and the transmitter may need to receive the sounding signal. Moreover, data communications can be bi-directional, with transceivers on both end nodes.

The expression “processing logic” should be understood as selected steps and decision blocks and/or hardware for implementing the selected steps and decision blocks. “Decision block” means a step in which a decision is made based on some condition, and process flow may be altered based on the outcome of the test.

Other and further explicit and implicit definitions and clarifications of definitions may be found throughout this document.

Reference will be made in detail to several embodiments that are illustrated in the accompanying drawings. Same reference numerals may be used in the drawings and this description to refer to the same apparatus elements and method steps. The drawings are in a simplified form, not to scale, and omit apparatus elements and method steps that can be added to the described systems and methods, while possibly including certain optional elements and steps.

Time Reversal (TR) is a communication technique that uses the reciprocity property of wave equations. It is described, for example, in U.S. patent application Ser. No. 13/142,236, entitled TECHNIQUES AND SYSTEMS FOR COMMUNICATIONS BASED ON TIME REVERSAL PRE-CODING, filed on 3 Sep. 2010 by David F. Smith and Anis Husain, which is hereby incorporated by reference in its entirety, as if fully set forth herein, including text, figures, claims, tables, and computer program listing appendices (if present). Briefly, in a system that uses time reversal, a pilot (e.g., a pulse) is sent from the target antenna of the Rx to the Tx; the Tx receives the pilot and captures in its high speed ADC the Channel Response (CR) of the channel between the Rx antenna and the Tx. The Tx may then be configured to send data back to the Rx by convolving a data stream with the time-reversed version of the captured CR. Standard modulation techniques can be used to apply the data to the signal by convolving a binary data stream with the TR-CR. For example, the Tx is configured to use a time reversed copy of the captured CR (TR-CR) as its data pulse. When a TR-CR is launched back down the same channel by the Tx, the actual physical channel that created the multipath now acts as its ideal (or near ideal, as the case may be in the real world) spatial-temporal matched filter and becomes a perfect equalizer for the signal, creating a pulse at the receiver that captures nearly all the energy present in the original CR, and hence creates multipath gain.

Simple and powerful Time Reversal techniques thus allow the use of single or multiple antennas to harvest multipath, creating signal gain. The techniques support focusing even in NLOS channels, with the resulting ability to focus a signal both spatially and temporally at a designated point in space within diffraction limits, without a priori knowledge of location of the intended receiver, in high multipath environments and when there is no direct path between the transmitter and the receiver. Time reversal may enable efficient peer-to-peer operation in NLOS environments, as well as opening the possibility of multicasting.

Other potential advantages of TR communications include robust and stable operation in urban environments, and superior performance with relatively low system complexity.

Selected systems and methods described in this document use scatterers located in the near-field of receiver antennas further to focus the received signal (such as a TR-focused signal) on the target received antennas. In some systems and methods, adjacent Rx antenna elements are spaced λ/5 (wavelength over 5), λ/10, λ/15, λ/30 intervals, or even closer. Such small spacing of antenna elements may have a number of benefits in selected embodiments. First, the size of the array can be decreased, and/or the number of the elements in an array of a given size increased. Higher data rates can thus be achieved, due to the ability to squeeze more antennas in a given volume or area.

Second, lower power consumption may also be achieved, due to the ability to use one transmit antenna and multiple receivers. Unlike MIMO where channel capacity may scale with the number of antennas either at the Tx or the Rx, TR channel capacity depends more strongly on the number of Rx antennas. Time reversal techniques can also add additional Tx antennas to obtain array gain, which allows a further reduction of transmit power for the same bit error rate (BER).

Third, lower interference with other systems may result because of the lower transmit signal power due to the high TR gain that can be reached in dense MP environments.

Fourth, near-field (NF) scatterers load the Rx antenna to create a “virtual” antenna that creates frequency dependent radiation patterns A(x, y, z, Freq, t). When the NF scatterers are distributed asymmetrically around the receiver antennas, their far-field radiation patterns will be different enabling TR to focus the received signal on the target receiving antenna while minimizing interference to the rest of the receiver antennas. Alternatively, frequency dependent radiation patterns can be obtained when the volume in the near-field of antennas becomes dispersive. Hence, metamaterial structures with negative index of refraction or high permittivity can also be used to focus the signals.

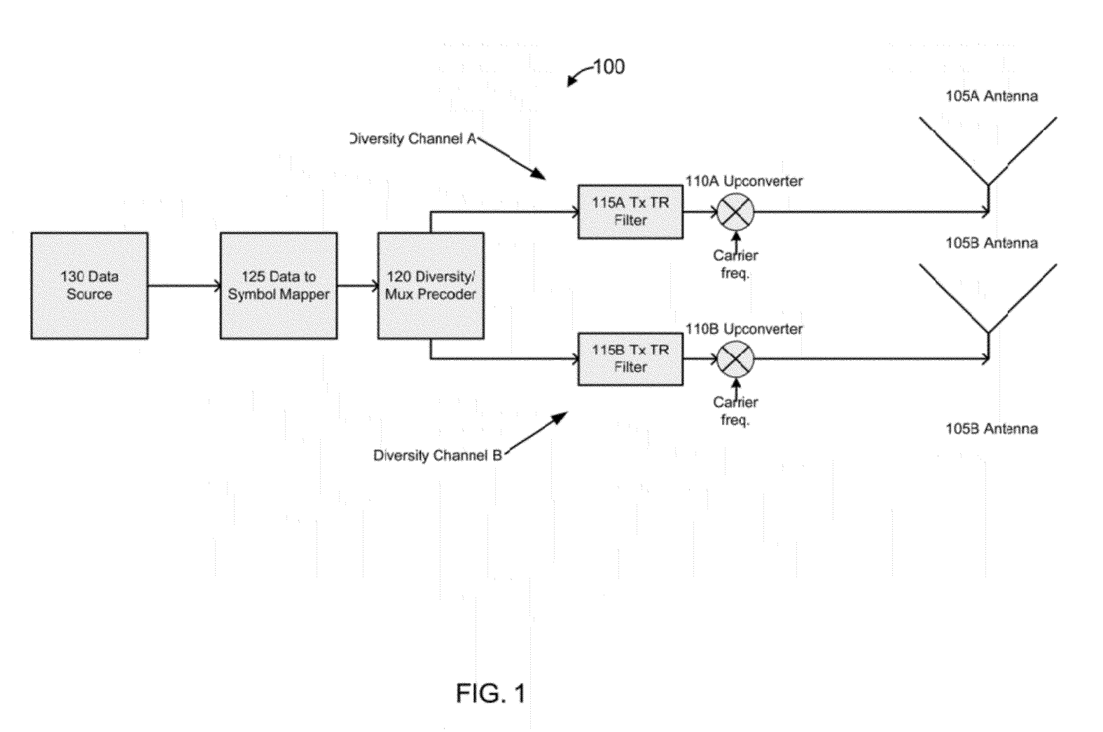

FIG. 1 is a block diagram showing selected elements (which may include optional elements) of a transmitter 100. As shown, the transmitter 100 has a data source 130, a data symbol mapper 125, a diversity multiplexer/precoder 120, transmit time reversal filters 115A/B, frequency upconverters 110A/B, and antennas 105A/B.

The data source 130 may include the MAC layer of the communication device, an interleaver, and forward error detection/correction encoder.

The data symbol mapper 125 is configured to receive the data from the data source 130 and map it into modulation symbols. It may be a modulator, for example, a QAM (Quadrature Amplitude Modulation), PPM (Pulse-Position Modulation), QPSK (Quadrature Phase-Shift Keying), or BPSK (Binary Phase-Shift Keying) modulator.

The diversity multiplexer/precoder 120 splits the symbols from the data symbol mapper 125 into two or more data streams, and sends the data streams to their respective transmit time reversal filters 115A and 115B. Each of the transmit time reversal filters 115 is configured to convolve its respective data stream with the time reversed estimate of the channel response of the channel between the transmitter 100 and the receiver antenna for which the data is intended. The filtered data from the filter 115A is sent to the frequency upconverter 110A, and the filtered data from the filter 115B is sent to the frequency upconverter 110B. Each of the upconverters may be a mixer that is configured to mix the data from its respective filter 115 with a local oscillator reference, and filter the result to select the desired sideband, which is the sideband at the RF carrier frequency.

The modulated carriers from the upconverters 110 are then sent to the antennas 105 connected to the respective upconverter, i.e., the modulated carrier from the upconverter 110A is sent to the antenna 105A, and the modulated carrier from the upconverter 110B is sent to the antenna 105B.

FIG. 1 shows the transmitter 100 with two antenna diversity channels (A and B), for illustration purposes. There may be more than two antenna diversity channels, meaning that the diversity multiplexer/decoder would split the data into more than two antenna diversity channels, and the transmitter would then have the corresponding number of channels, for example, with each channel having a respective transmit time reversal filter, upconverter, and antenna. Further, the transmitter 100 may be made without antenna diversity, having a single channel, for example, a channel such as one of the channels A or B, including a single transmit time reversal filter, a single upconverter, and a single antenna.

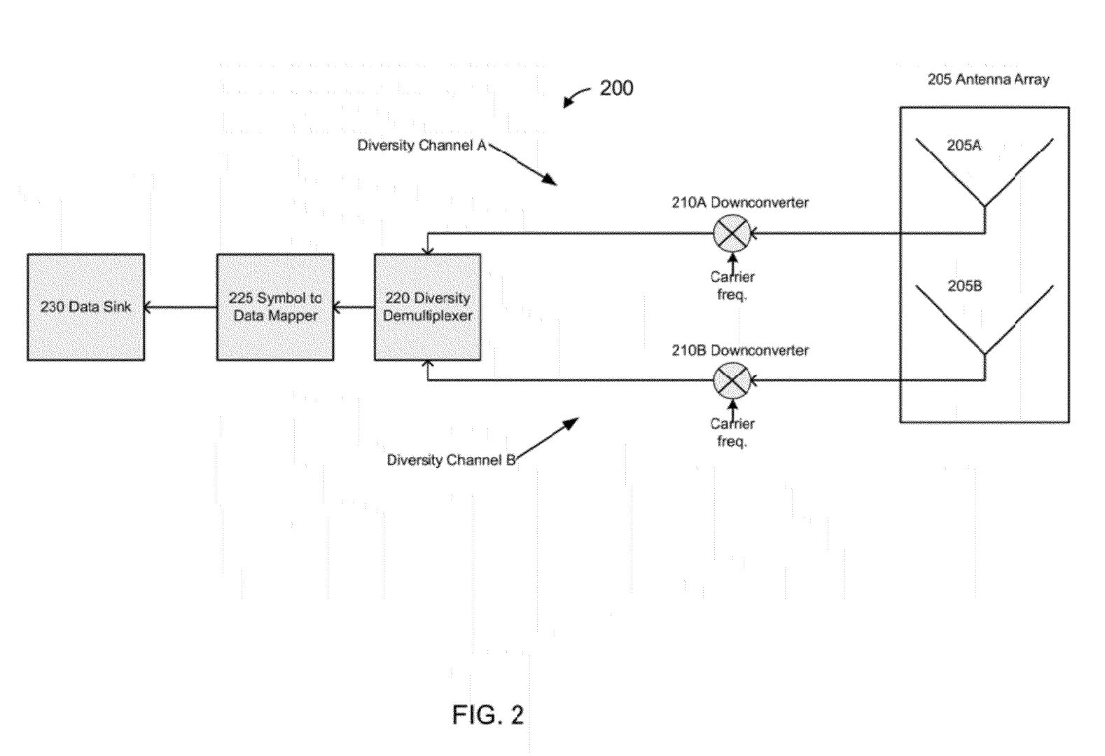

FIG. 2 is a block diagram showing selected elements (which may include optional elements) of a receiver 200, configured to operate cooperatively with the transmitter 100. As shown, the receiver 200 has a data sink 230, a symbol-to-data mapper 225, a diversity demultiplexer/decoder 220, frequency downconverters 210A/B, and antennas 205A/B in an antenna array 205.

The antennas 205A/B receive (through the channel between the receiver 200 and the transmitter 100) RF signals emitted by the antennas of the transmitter 100. Each of the antennas 205A/B is coupled to its respective downconverter 210, so that the RF signal flows from the particular antenna to its downconverter. The function of each of the downcoverters is to shift the received signal at the antenna to a baseband or to an intermediate frequency. Each of the downconverters may be a mixer that is configured to mix the data from its respective antenna with a local oscillator reference, and filter the result to select the desired sideband, which is the baseband or the intermediate frequency sideband, usually the lower frequency sideband. The local oscillator frequency at the receiver 200 may be the same as the local oscillator frequency of the transmitter 100, or it may be a different frequency. We contemplate any relationship between the local oscillator frequencies at the transmitter 100 and the receiver 200; also, there may be more than a single downconversion or upconversion stage in each of the channels.

The outputs of the downcoverters 210A/B are coupled to the inputs of the diversity demultiplexer 220, which is configured to perform the inverse function of the diversity multiplexer/precoder 220 of the transmitter 100, assembling the data of the different channels (A/B) into a data stream.

The output of the diversity multiplexer/precoder 220 is connected to the symbol-to-data mapper 225, which can be a demodulator configured to perform the inverse function of the modulator 125 of the transmitter 100. In other words, it converts modulated symbols into data. If the modulator 125 is a BPSK modulator, then the demodulator 225 is a BPSK demodulator; if the modulator 125 is a QPSK modulator, then the demodulator 225 is a QPSK demodulator; if the modulator 125 is a QAM modulator, then the demodulator 225 is a QAM demodulator; and if the modulator 125 is a PPM modulator, then the demodulator 225 is a PPM demodulator. This are, of course, merely exemplary variants.

The data stream from the symbol-to-data mapper 225 flows to the data sink 230, which may include a de-interleaver, forward error detection/correction decoder, and the MAC layer of the receiver 200.

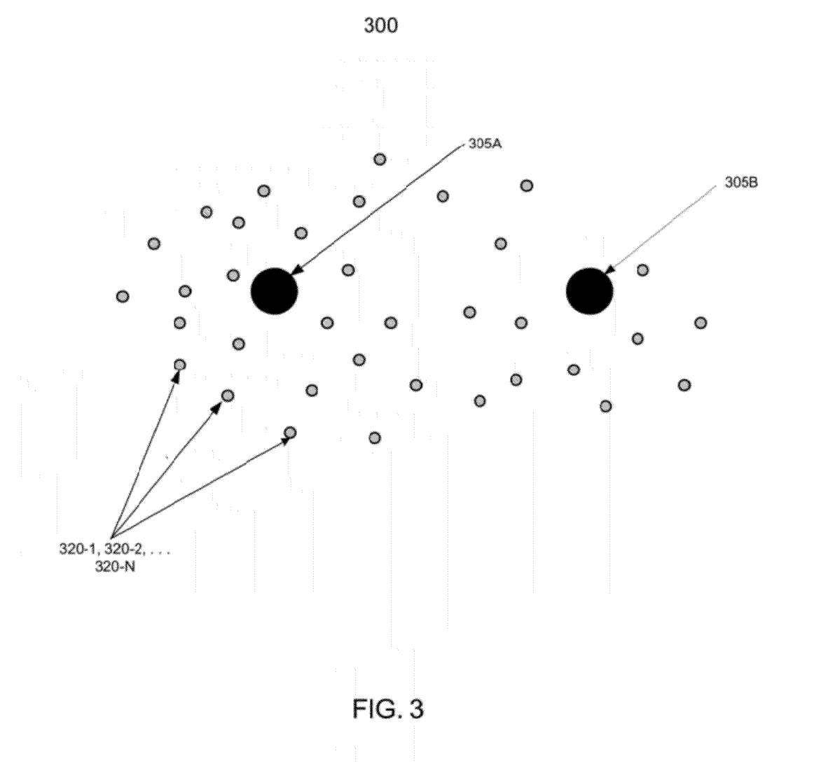

FIG. 3 illustrates, in a schematic two-dimensional manner, selected elements of an embodiment of a receive antenna array 300, such as the antenna array 205 in FIG. 2. As shown, the receive antenna array 300 includes two antenna elements, 305A and 305B, each of which can be, for example, a monopole antenna element. In this embodiment, the antenna elements 305A and 305B are spaced less than ½ wavelength (λ) apart, at center frequency of operation, as well as at the lowest frequency of the operating band of the communication device. In embodiments, the spacing between the two antenna elements may be λ/5 (wavelength over 5), λ/10, λ/15, λ/30 intervals, or even less, for all wavelengths (or the longest wavelength, or the center wavelength) of the design band of the communication system.

A plurality of near-field scatterers (“NF scatterers”) 320-1 through 320-N surrounds the antenna elements 305. When one of the beams of far field radiation in the band of interest is incident upon the receive antenna array, the NF scatterers 320 create a complex electromagnetic pattern, in phase and amplitude, near the antenna elements 305. The different beams may result from a plurality of antennas (antenna elements) at the transmitter, such as the antennas 105A and 105B of the transmitter 100. When a single transmit antenna is present, the different beams may be created by multipath in the far field (much farther than λ from the antenna array, e.g., farther than 10λ). When using a single antenna transmitter, multipath may be sufficient for the operation of the receiver 200 if the two highest energy components differ by 10 dB or less, for example. The different beams may also be created by a combination of far field multipath and multiple transmit antennas.

Because the NF scatterers 320 are arranged not symmetrically in relation to the placement of the antenna elements 305, the effective patterns of the different antenna elements 305 differ. Thus, there may be substantial difference at the frequencies of interest between the pattern of the antenna element 305A and the pattern of the antenna element 305B.

Note that although the arrows from the numerals 320 in FIG. 3A extend only to three of the scatterers 320, we refer to all the smaller elements in FIG. 3A as the NF scatterers 320. Note also that although FIG. 3 is two-dimensional, the scatterers may be present in all three dimensions.

Without the asymmetrically positioned NP scatterers, each of the different beams randomly collimating upon the receiver antenna array might look substantially the same from the vantage point of two adjacent (or even all) antenna elements 305. The asymmetrical NF scatterers 320 distort the near-field, so that the antenna patterns differ significantly from one antenna element 305 to another (from 305A to 305B, for example). “Significantly” here means sufficiently to enable targeting each of the antenna elements from the transmitter 100, despite the close spacing (sub-half wavelength) of the antenna elements 305. Because of the different antenna patterns that result due to the presence of the NF scatterers 320, the antenna elements 305 are effectively decoupled from each other.

In FIG. 3, the NF scatterers 320 are distributed asymmetrically relative to the antenna elements 305, but they have orientation (E-field polarization) similar or identical to that of the antenna elements 305. In variants, the polarization of the scatterers 320 is the same as or substantially the same as the polarization of the antenna elements 305, so that the scatterers 320 interact efficiently (in the electromagnetic sense) with the antenna elements 305. In variants, the spacing of at least some (one or more) of the scatterers 320 from one or more of the antenna elements 305 is less than the spacing between the adjacent antenna elements 305. In variants, the spacing of at least some of the scatterers 320 from one or more antenna elements 305 is less than 0.2λ, less than 0.15λ, less than 0.1λ, less than 0.05λ, less than 0.03λ, or less than 0.01λ.

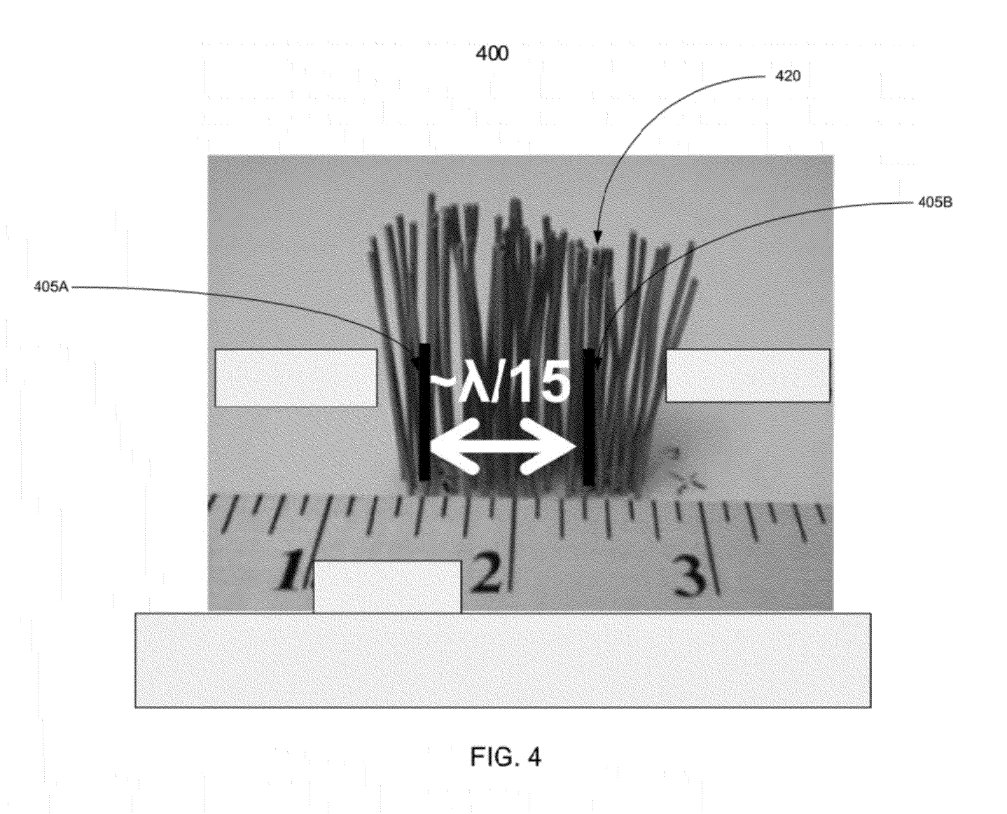

FIG. 4 illustrates selected elements of an embodiment of a receive antenna array 400, such as the antenna array 205 in FIG. 2. A ruler with inch and fractional divisions is shown in the foreground of the drawing, for reference. In FIG. 4, two wire-like antenna elements 405A and 405B are arranged in parallel (or substantially in parallel), one-fifteenth λ apart. The antenna elements 405A and 405BB are located within a large number of wire-like near-field scatterers 420, randomly and asymmetrically surrounding the antenna elements 405. In this “forest”-like structure, the NF scatterers 420 (or some of them) are substantially parallel to the antenna elements 405, but some may deviate quite substantially from the strict parallel direction. Although the antenna elements 405A and 405B may appear to be in front of the NF scatterers 420, they are in fact within the “thicket” of the scatterers 420.

The number of NF scatterers may vary. In particular embodiments, there may be 12-13 NF scatterers; 40-50 NF scatterers; and 100 scatterers or more. Intermediate numbers of NF scatterers (14-39, 51-100) may also be used. Here, the number of scatterers refers to the number of near-field scatterers, for example, scatterers within one-half wavelength (at the center frequency of operation, or at the lowest frequency of the operating band of the communication device).

The NF scatterers may be designed for efficient operation (scattering) at about the same frequency as the antenna elements. They may but do not necessarily have to be the same length as the antenna elements. In embodiments, the lengths of individual NF scatterers vary, some being longer than others, for broader bandwidth.

Conductive wire (e.g., copper wire) may be used to manufacture the NF scatterers. For miniaturization, metal interconnect lines may be placed on a printed circuit board (PCB) using standard PCB fabrication processes (e.g., etching on a substrate using photolithography to processes). For three-dimensional placement of the NF scatterers, the NF scatterers may be fabricated in different layers of the PCB.

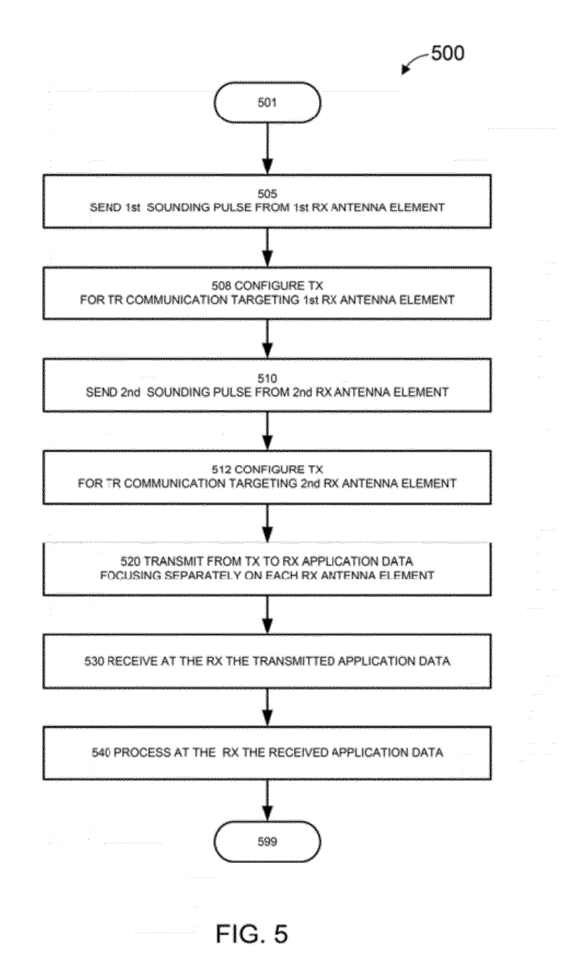

FIG. 5 shows selected steps (including, if applicable, decision blocks) of a communication process 500 that uses time reversal and near-field scatterers at the receiver. The process may be performed by a receiver and transmitter such as those illustrated in FIG. 1 and FIG. 2.

At flow point 501, the receiver and the transmitter are powered up and configured to perform the steps of the communication process 500.

In step 505, the receiver sends to the transmitter a sounding pulse from the first antenna element of the receiver. The shape of this and other sounding pulses may be substantially an impulse function, a Gaussian function, or another function.

In step 508, the transmitter configures itself for TR communication targeting the first antenna element of the receiver. This step may include receiving the transmission of the sounding pulse from the first receiver antenna element, determining a first channel response between the transmitter and the first receiver antenna element, time-reversing the first channel response to obtain a first TR channel response, and storing the first TR channel response.

In step 510, the receiver sends to the transmitter a sounding pulse from the second antenna element of the receiver.

In step 512, the transmitter configures itself for TR communication targeting the second antenna element of the receiver. This step may include receiving the transmission of the sounding pulse from the second receiver antenna element, determining a second channel response between the transmitter and the second receiver antenna element, time-reversing the second channel response to obtain a second TR channel response, and storing the second TR channel response.

In variants with more than two receiver antenna elements, steps similar to 505/508 and 510/512 may be performed for the additional receiver antenna elements, mutatis mutandis. This is not shown in FIG. 5.

Note that despite the receiver antenna elements separation below the diffraction limit, the transmitter can target the individual antenna elements of the receiver. This is so because of (1) the generation of multiple “beams” by multiple antenna elements at the transmitter and/or multipath, and/or (2) the presence of near-field scatterers at the receiver antenna array. The multiple receive antenna elements are thus decoupled even at separations much below the diffraction limit.

In step 520, the transmitter transmits application or other payload data to the receiver, using time reversal to focus separately on each of the multiple receiver antenna elements. For example, the transmitter convolves the application data for the first receiver antenna element with the first TR channel response, and transmits the result of the first convolution; and the transmitter convolves the application data for the second receiver antenna element with the second TR channel response, and transmits the result of the second convolution. The first channel (between the transmitter and the first receiver antenna element) then acts as the near-perfect filter for the first receiver antenna element, and the second channel (between the transmitter and the second receiver antenna element) acts as the near-perfect filter for the second receiver antenna element.

In step 530, the receiver receives the application data for the first and second receiver antenna elements.

In step 540, the receiver processes the received data. For example, the receiver may demodulate, deinterleave, and error-correct the data received through each of the channels, and send the data to a targeted application on the receiver side.

The process 500 here terminates at flow point 599. Note, however, that the process or parts of it may be repeated as needed. For example, additional application data may be transmitted, received, and processed, essentially repeating the steps 520, 530, and 540. Moreover, new sounding pulses may be sent from the receiver to the transmitter, and the transmitter re-configured based on the channel responses it obtains from the new sounding pulses, before transmitting additional application data. Here, in essence, the entire process 500 can be repeated.

The embodiments described above are illustrative and not necessarily limiting, although they or their selected features may be limiting for some claims. In particular, different kinds of antenna elements and different kinds of NF scatterers may be used. More than two receiver antenna elements may also be used, for example, three, four five, or more receiver antenna elements. The receiver antenna elements may, but not necessarily have to, be arranged in the same plane. In selected receiver embodiments, the polarization of at least some NF scatterers is the same or substantially the same as the polarization of the receiver antenna elements, to enhance interaction of the NF scatterers with the antenna elements. In selected transmitter embodiments, the transmitter uses a single antenna or antenna element; in other embodiments, the transmitter uses two or more antennas or antenna elements.

The features described throughout this document may be present individually, or in any combination or permutation, except where presence or absence of specific elements/limitations is inherently required, explicitly indicated, or otherwise made clear from the context.

In selected embodiments, TR and NF scatterers communication techniques are combined to allow targeting different closely spaced (sub-lambda/2) antennas of one or more receivers, potentially increasing the capacity of the system by the factor of the antenna quantity, for example, doubling the capacity for a two-element antenna array. Also, the robustness and noise/interference immunity of communications can be increased; or some combination of these improvements can be achieved without a commensurate increase in antenna array size and/or transmit power.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium known in the art. An exemplary storage medium is coupled to the processor such that the processor can read information from, and write information to, the storage medium. In an alternative, the storage medium may be integral to the processor.

Having thus described in detail selected embodiments, it is to be understood that the foregoing description is not necessarily intended to limit the spirit and scope of the invention(s).

This document describes in detail the inventive apparatus, methods, and articles of manufacture for facilitating integration of external devices with a vehicle entertainment system. This was done for illustration purposes only. Neither the specific embodiments of the invention(s) as a whole, nor those of its (or their, as the case may be) features necessarily limit the general principles underlying the invention(s). The specific features described herein may be used in some embodiments, but not in others, without departure from the spirit and scope of the invention(s) as set forth herein. Various physical arrangements of components and various step sequences also fall within the intended scope of the invention(s). Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention(s) and the legal protection afforded the invention(s), which function is carried out by claims and their equivalents.

What is claimed is:

1. A radio antenna array, comprising:
a plurality of antenna elements electrically insulated from each other, each antenna element of the plurality of antenna elements being configured to operate in a predetermined radio frequency (RF) band; and
a plurality of near-field (NF) scatterers;
wherein:
the plurality of antenna elements comprises a first antenna element and a second antenna element, the first antenna element being separated from the second antenna element by a distance d, d being less than one-half wavelength at center frequency of the predetermined RF band; and
the NF scatterers of the plurality of NF scatterers arc distributed asymmetrically relative to the first and second antenna elements, each NF scatterer of a first subset of the NF scatterers of the plurality of NF scatterers is located nearer the first antenna element than d.

2. A radio antenna array according to claim 1, wherein:
each NF scatterer of a second subset of the NF scatterers of the plurality of NF scatterers is located nearer the second antenna element than d; and
each antenna element of the array of antenna elements is coupled to a different input of a receiver.

3. An apparatus for receiving data transmissions, the apparatus comprising:
the radio antenna array according to claim 2; and
an electronic receiver portion configured to operate in the predetermined frequency band using time reversal, the electronic receiver portion comprising a plurality of antenna inputs, each antenna element of the array of antenna elements being coupled to a different input of the plurality of antenna inputs of the electronic receiver portion;
wherein d is less than one-half wavelength at all frequencies of the predetermined RF band.

4. An apparatus for receiving data transmissions according to claim 3, wherein the plurality of antenna elements comprises more than two antenna elements, and each pair of adjacent antenna elements of the plurality of antenna elements is separated by a distance not greater than d.

5. An apparatus for receiving data transmissions according to claim 4, wherein d is not more than ⅕ wavelength at all frequencies of the predetermined RF band.

6. An apparatus for receiving data transmissions according to claim 4, wherein d is not more than 1/10 wavelength at all frequencies of the predetermined RF band.

7. An apparatus for receiving data transmissions according to claim 4, wherein d is not more than 1/30 wavelength at all frequencies of the predetermined RF band.

8. An apparatus for receiving data transmissions according to claim 4, wherein d is not more than 1/15 wavelength at all frequencies of the predetermined RF band.

9. An apparatus for receiving data transmissions according to claim 8, wherein:
each NF scatterer of the first subset of the NF scatterers of the plurality of NF scatterers is located nearer the first antenna element than s; and
each NF scatterer of the second subset of the NF scatterers of the plurality of NF scatterers is located nearer the second antenna element than s; and
s is less than 0.02 wavelength at all frequencies of the predetermined RF band.

10. An apparatus for receiving data transmissions according to claim 8, wherein:
each NF scatterer of the first subset of the NF scatterers of the plurality of NF scatterers is located nearer the first antenna element than s; and
each NF scatterer of the second subset of the NF scatterers of the plurality of NF scatterers is located nearer the second antenna element than s; and
s is less than 0.01 wavelength at all frequencies of the predetermined RF band.

11. An apparatus for receiving data transmissions according to claim 8, wherein:
each NF scatterer of the first subset of the NF scatterers of the plurality of NF scatterers is located nearer the first antenna element than s; and
each NF scatterer of the second subset of the NF scatterers of the plurality of NF scatterers is located nearer the second antenna element than s; and
s is less than 0.03 wavelength at all frequencies of the predetermined RF band.

12. An apparatus for receiving data transmissions according to claim 8, wherein:
each NF scatterer of the first subset of the NF scatterers of the plurality of NF scatterers is located nearer the first antenna element than s; and
each NF scatterer of the second subset of the NF scatterers of the plurality of NF scatterers is located nearer the second antenna element than s; and
s is less than 0.05 wavelength at all frequencies of the predetermined RF band.

13. An apparatus for receiving data transmissions according to claim 12, wherein the plurality of NF scatterers comprises at least 100 NF scatterers.

14. An apparatus for receiving data transmissions according to claim 40, wherein the plurality of NF scatterers comprises at least 40 NF scatterers.

15. An apparatus for receiving data transmissions according to claim 12, wherein the plurality of NF scatterers comprises at least 12 NF scatterers.

16. An apparatus for receiving data transmissions according to claim 15, wherein polarization of each NF scatterer of the plurality of NF scatterers is identical or substantially identical to polarization of the first and second antenna elements.

17. An apparatus for receiving data transmissions according to claim 15, wherein lengths of the NF scatterers of the plurality of NF scatterers vary to increase operating bandwidth of the radio antenna array.

18. An apparatus for receiving radio frequency data transmissions, the apparatus comprising:
an electronic receiver configured to operate in a predetermined frequency band using time reversal, the electronic receiver comprising a plurality of antenna inputs; and
a multi-element antenna means for receiving electronic transmissions in the predetermined frequency band separately targeting each element of the multi-element antenna means;
wherein elements of the multi-element antenna means are spaced less than diffraction limit of the predetermined frequency band.

19. A method of transmitting data wirelessly from a transmitter to a receiver using time reversal communications in a predetermined radio frequency band, the method comprising:
estimating a first channel response between the transmitter and a first antenna element of the receiver;
estimating a second channel response between the transmitter and a second antenna element of the receiver;
temporally and spatially focusing a first transmission of first data from the transmitter on the first antenna element; and
temporally and spatially focusing a second transmission of second data from the transmitter on the second antenna element, the second antenna element being separated from the first antenna element by less than diffraction limit associated with the predetermined radio frequency band;
wherein the first and second transmissions are sent concurrently.

20. A method of receiving data wirelessly from a transmitter at a receiver using time reversal communications in a predetermined radio frequency band, the method comprising:
sending a first sounding pulse from a first antenna element of the receiver to the transmitter;
sending a second sounding pulse from a second antenna element of the receiver to the transmitter;
receiving at the receiver through the first antenna element a first transmission temporally and spatially focused by the transmitter on the first antenna element; and
receiving at the receiver through the first antenna element a first transmission temporally and spatially focused by the transmitter on the first antenna element, the second antenna element being separated from the first antenna element by less than diffraction limit associated with the predetermined radio frequency band;
wherein the first and second transmissions are received concurrently.
